(19) United States
(12) Patent Application Publication
(10) Pub. No.: US 2025/0272971 A1
(43) Pub. Date: Aug. 28, 2025

(54) Configurable Multi-Camera and Multi-Viewpoint Inferencing System Utilizing a Domain-Specific Language for Enhanced Object and Behavior Detection

(71) Applicants: Karthikeyan Subramaniam, Princeton, NJ (US); Karthikeyan Ramasubramaniraja, Princeton, NJ (US)

(72) Inventors: Karthikeyan Subramaniam, Princeton, NJ (US); Karthikeyan Ramasubramaniraja, Princeton, NJ (US)

(21) Appl. No.: 19/058,094

(22) Filed: Feb. 20, 2025

Related U.S. Application Data
(60) Provisional application No. 63/559,122, filed on Feb. 28, 2024.

(51) Int. Cl. G06V 10/96; G06V 10/94; G06V 20/40; G06V 20/52

(52) U.S. Cl. CPC G06V 10/96; G06V 10/945; G06V 20/41; G06V 20/52

(57) ABSTRACT

This invention introduces a versatile system and methodology for configurable video inferencing analysis, utilizing a domain-specific language (DSL) to define detailed specifications for video analysis tasks across various domains, including but not limited to security surveillance, traffic monitoring, industrial automation, retail behavior analysis, and environmental observation. The modular architecture of the system encompasses an orchestrator module, multiple inferencing modules (watchers), a data management module, and a publication module, each tailored to execute configurations delineated in the DSL. This DSL supports a wide array of formats such as YAML, JSON, and XML, catering to diverse user preferences and integration requirements.

### 1. BACKGROUND

The field of video analysis has broadened significantly, with applications now spanning not just traditional security surveillance but also including advanced use cases such as machine and worker productivity and safety monitoring, inventory management, and yield calculations. Despite the potential for impactful insights in these areas, current solutions often fall short, offering basic functionalities like simple polygon-based people counting provided by camera vendors. These systems, while useful for straightforward applications, lack the comprehensive and flexible features necessary to tackle more sophisticated business challenges.

For instance, in the context of industrial operations, monitoring machine and worker productivity alongside safety compliance requires a nuanced analysis of video data. Current tools, typically designed for generic monitoring tasks, are inadequate for such specific and complex requirements. They cannot, for example, accurately track worker movements in relation to machinery to assess productivity metrics or identify potential safety violations in real-time. Similarly, in the agricultural, retail, manufacturing, power plants sectors, calculating yields or inventory levels from video data involves sophisticated analysis that goes beyond mere object counting. It requires the ability to understand context, differentiate between various items or conditions, and make accurate estimations based on visual information.

These advanced use cases often necessitate custom development projects to achieve the desired video analysis capabilities. However, custom solutions come with their own set of challenges, including high development costs, longer implementation times, and difficulties in adapting to changing requirements or scaling across different operational contexts. This reliance on bespoke projects to fulfill advanced video analysis needs highlights a significant gap in the market for a versatile, scalable, and easily configurable video analysis system.

Our invention addresses this gap by providing a comprehensive solution capable of accommodating sophisticated business use cases through a configurable, domain-specific language (DSL). This approach allows for detailed specification of video analysis tasks, enabling users to tailor the system to specific operational needs, such as monitoring worker and machine interactions for productivity and safety insights or conducting complex inventory and yield calculations. By offering a scalable and flexible platform, our invention eliminates the need for costly custom projects, providing businesses across various sectors with the tools necessary to leverage advanced video analysis capabilities efficiently and effectively.

### BRIEF DESCRIPTION OF THE DRAWINGS

FIG. 1 illustrates the system architecture highlighting the interaction between DSL, Orchestrator and Inferencing modules;

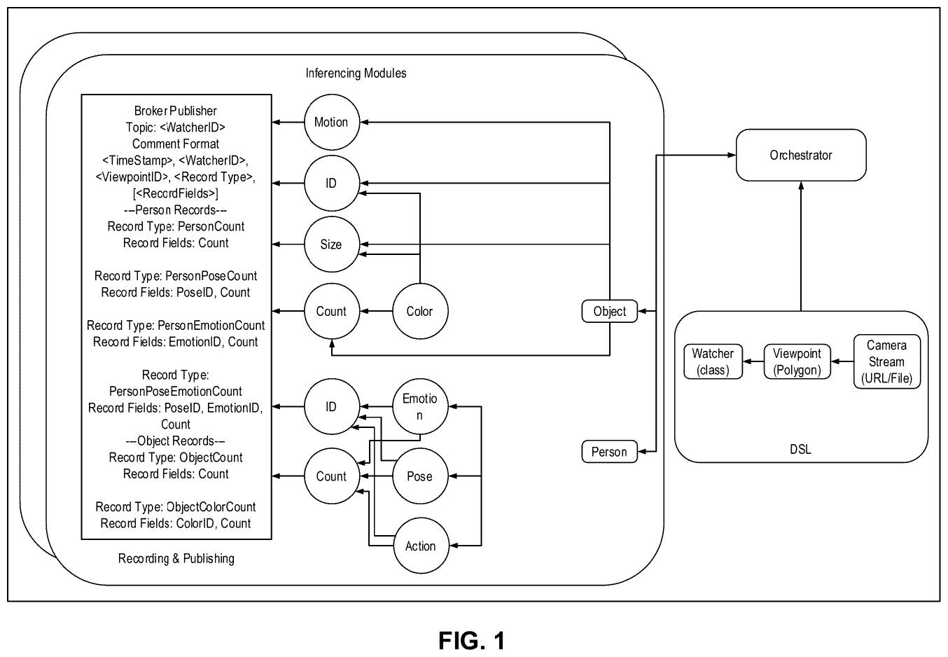

FIG. 2A illustrates a portion of the overall solution implementation of the system highlighting the processing of records created by the inferencing modules;

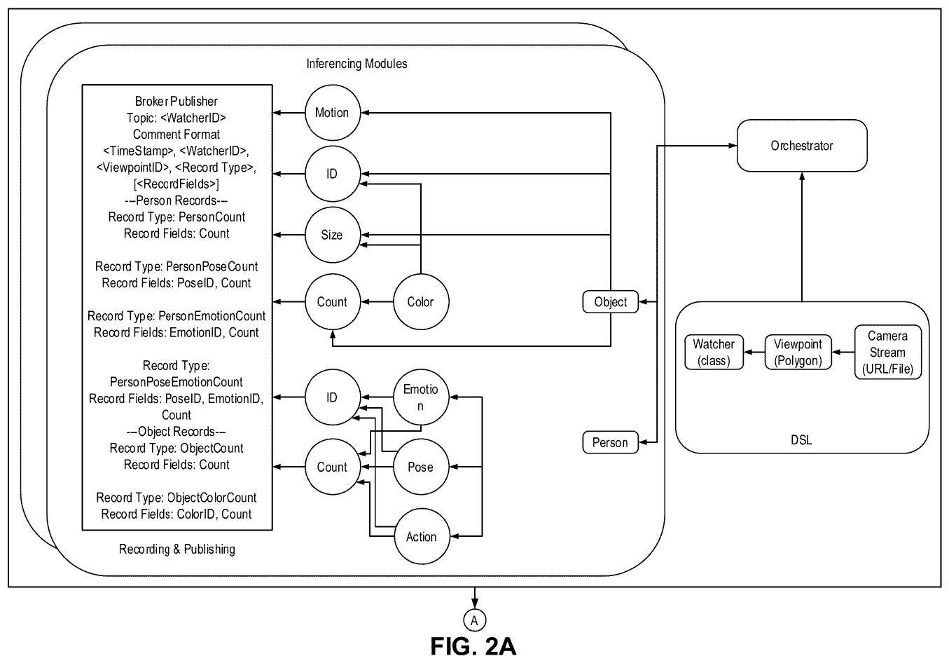

FIG. 2B illustrates another portion of the overall solution implementation of the system highlighting the processing of records created by the inferencing modules;

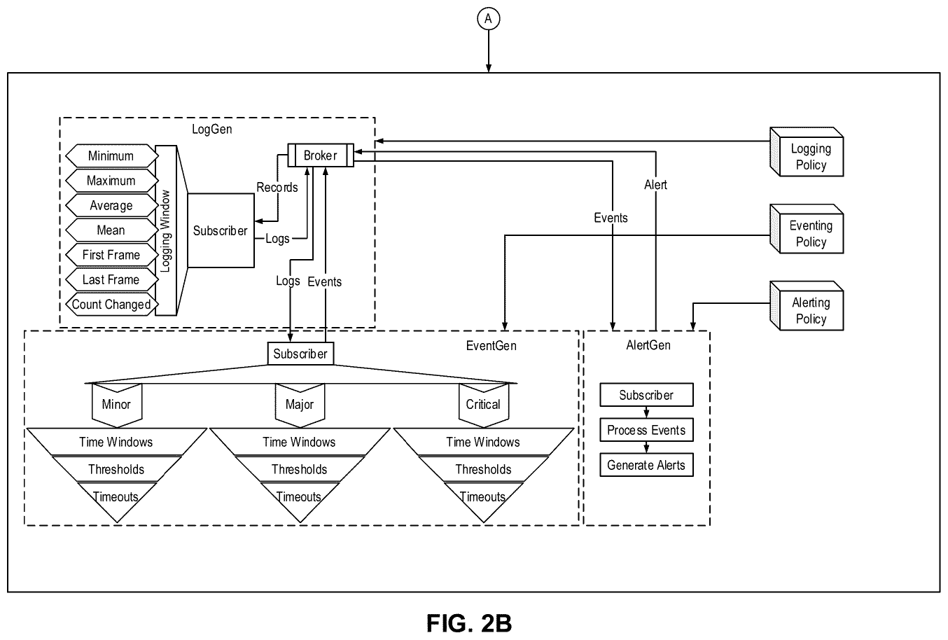

FIG. 3A illustrates a portion of the user interaction and a practical usage scenario; and

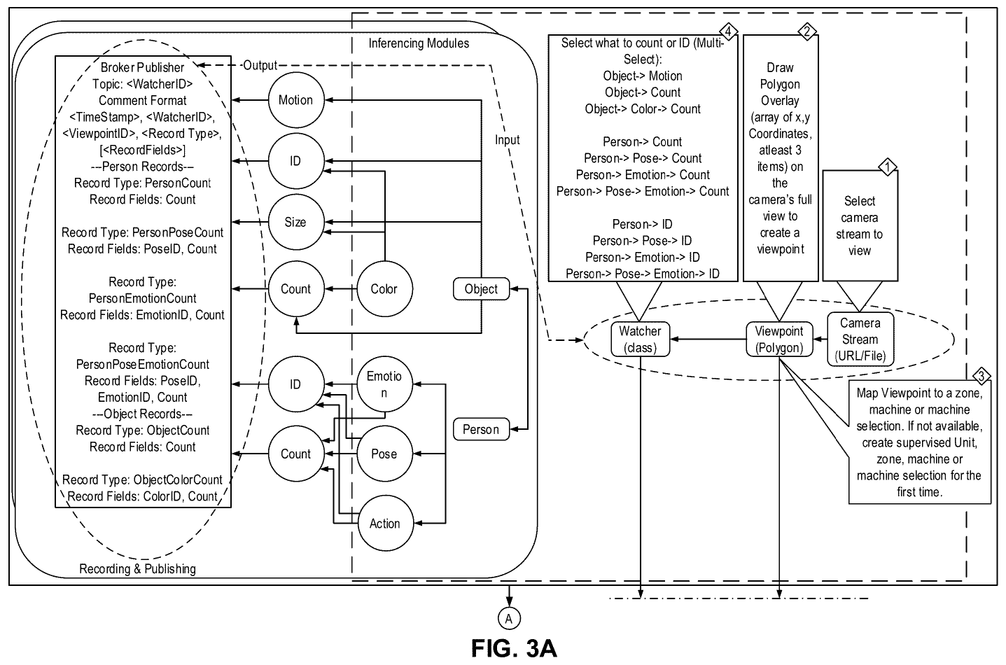

FIG. 3 illustrates another portion of the user interaction and a practical usage scenario.

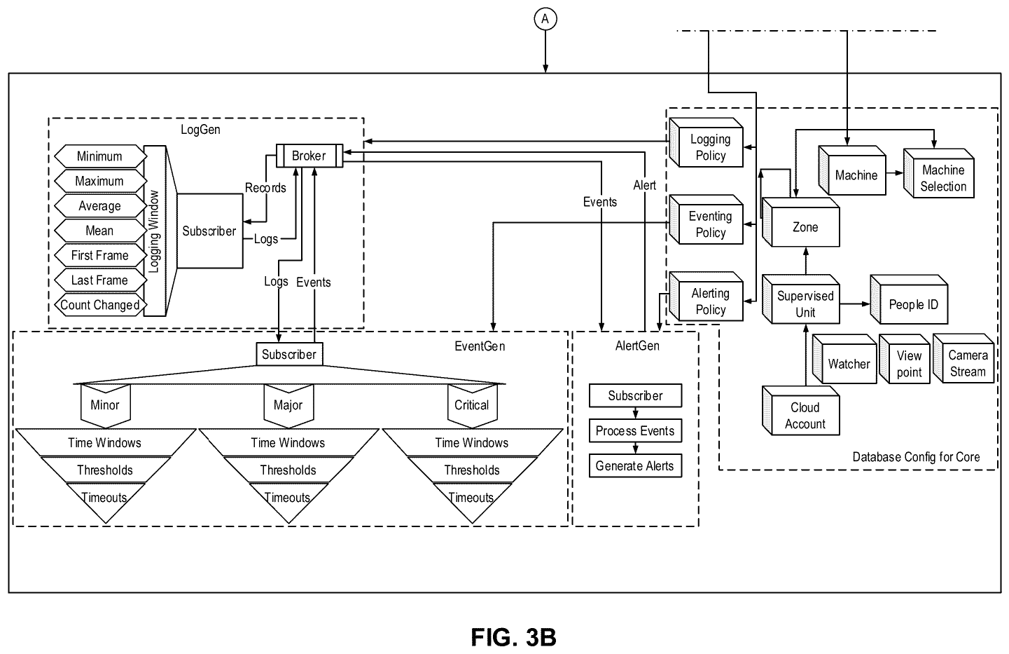

### DETAILED DESCRIPTION

### 2.1 Overview of the Invention

This invention presents a system and method for video inferencing that utilizes a Domain-Specific Language (DSL) to facilitate the configuration and execution of video analysis tasks across a variety of applications. The system is designed with a modular architecture, comprising an orchestrator module, inferencing modules (also referred to as watchers), a data management module, and a publication module. Each component is integral to the operation of the system, working in concert to process video data from initialization through to the dissemination of results. The DSL is central to the system's functionality, enabling users to specify parameters for video sources, inferencing criteria, recording policies, and mechanisms for publishing data.

Central to the system's operation is the orchestrator module, which interprets the DSL input to dynamically allocate video streams to inferencing modules based on designated viewpoints. Each inferencing module applies specified detectors for identifying objects, behaviors, or events of interest, embodying the system's adaptability by facilitating real-time updates to the DSL configurations and promoting scalability through the seamless integration of additional modules or detectors as needed.

The method outlined by the invention details a comprehensive process for configuring, processing, and analyzing video streams, incorporating advanced features such as real-time configuration adaptation, automated detection of areas of interest, adaptive detector selection based on video content characteristics, and sophisticated recording strategies that optimize data storage and processing.

Furthermore, the modular architecture enables extensive customization and scalability, allowing for the development and integration of custom inferencing modules, the adjustment of detector parameters via DSL, and the implementation of automated data management strategies. Designed for both traditional on-premises deployment and cloud-based operation, the system ensures flexibility, high availability, and broad applicability across a multitude of video inferencing applications beyond traditional surveillance, including traffic flow analysis, monitoring of industrial processes, studying consumer behavior in retail environments, and observing natural environments for research or conservation efforts.

The system is designed to address the need for a flexible, scalable solution in video analysis, capable of supporting complex applications beyond conventional surveillance.

These include, but are not limited to, monitoring industrial operations for productivity and safety, managing inventory, calculating yields, and analyzing traffic flows. By providing a DSL for configuration, the system allows for detailed specification and modification of video analysis tasks without requiring in-depth technical knowledge, thereby lowering the barrier to entry for users across sectors.

The modular design of the system ensures scalability and adaptability, accommodating the incorporation of additional video sources and the expansion of inferencing capabilities as required. This design principle supports the system's ability to evolve in response to technological advancements and changing user needs. Furthermore, the system's architecture facilitates integration with external platforms for data management and analysis, enhancing the utility and applicability of the generated insights.

In order to ensure clarity and precision throughout this document, this section provides definitions for critical terms and concepts related to the enhanced video inferencing system. These definitions are intended to provide a clear understanding of the terminology used within the context of this invention.

### Video Inferencing

“Video Inferencing” refers to the process of analyzing video streams in real-time or from recorded footage to detect, classify, and interpret visual information within predefined parameters. This process involves the application of machine learning algorithms and analytical models to identify objects, behaviors, patterns, or anomalies within video data, facilitating automated decision-making or alerting based on visual cues.

### Domain-Specific Language (DSL)

A “Domain-Specific Language (DSL)” is a programming or configuration language dedicated to a particular problem domain, offering specialized syntax and commands tailored to the specific needs of that domain. In the context of this invention, the DSL is designed to allow users to define video analysis tasks, including specifying video sources, analysis parameters, integration points with industrial systems, and response actions.

### Programmable Logic Controllers (PLC)

“Programmable Logic Controllers (PLC)” are industrial digital computers which have been ruggedized and adapted for the control of manufacturing processes, such as assembly lines, robotic devices, or any activity that requires high reliability control and ease of programming and process fault diagnosis.

### IO-Link

“IO-Link” is an open standard serial communication protocol used to connect sensors and actuators to an automation system. IO-Link enables bidirectional data exchange and provides detailed device diagnostics, simplifying wiring and data accessibility at the sensor/actuator level.

### OPC Unified Architecture (OPC UA)

“OPC Unified Architecture (OPC UA)” is a machine-to-machine communication protocol for industrial automation developed by the OPC Foundation. It offers secure, reliable, and platform-independent data exchange, facilitating interoperability among various industrial devices and systems.

### Message Queuing Telemetry Transport (MQTT)

“Message Queuing Telemetry Transport (MQTT)” is a lightweight messaging protocol designed for limited bandwidth and unreliable networks, commonly used in connecting remote devices to the Internet in the Internet of Things (IoT) applications.

### SCADA

“Supervisory Control and Data Acquisition (SCADA)” systems are control systems architecture that uses computers, networked data communications, and graphical user interfaces for high-level process supervisory management, but use other peripheral devices such as programmable logic controllers and discrete PID controllers to interface with the process plant or machinery.

### Manufacturing Execution Systems (MES)

“Manufacturing Execution Systems (MES)” are computerized systems used in manufacturing to track and document the transformation of raw materials to finished goods, providing information that helps manufacturing decision makers understand how current conditions on the plant floor can be optimized to improve production output.

### Enterprise Resource Planning (ERP)

“Enterprise Resource Planning (ERP)” refers to a type of software that organizations use to manage day-to-day business activities such as accounting, procurement, project management, risk management and compliance, and supply chain operations.

### Warehouse Management Systems (WMS)

“Warehouse Management Systems (WMS)” are software applications designed to support and optimize warehouse or distribution center management. They facilitate management in their daily planning, organizing, staffing, directing, and controlling the utilization of available resources, to move and store materials into, within, and out of a warehouse, while supporting staff in the performance of material movement and storage in and around a warehouse.

### 2.2 DSL for Video Inferencing

The Domain-Specific Language (DSL) devised for this video inferencing system is meticulously structured to offer an intuitive yet powerful means for specifying all aspects of video surveillance and analysis tasks. The DSL facilitates comprehensive configuration through various key elements, enabling precise control over video stream sources, inferencing intervals, recording policies, data publishing mechanisms, and detailed specifications of viewpoints for focused inferencing. This section elucidates the DSL structure using the provided sample file as an illustrative example.

### 2.2.1 Video Stream Configuration

The ‘VideoStream’ section allows users to specify the source of the video feed. It supports direct file paths (‘File: ″″’) for recorded video playback or URL links (‘URL: ″″’) for streaming video sources, providing flexibility in selecting the video input. This dual capability ensures that the system can cater to both real-time surveillance needs and post-event analysis scenarios.

### 2.2.2 Inferencing Interval

The ‘IntervalTimeInSeconds’ field defines the temporal granularity at which the video is analyzed. Setting this interval to ‘10’ seconds, for example, directs the system to process video frames and execute inferencing tasks at this frequency. This parameter offers a balance between real-time responsiveness and computational efficiency, allowing users to tailor the system's performance to the specific requirements of their application.

### 2.2.3 Recording Policy

Under ‘RecordCreationPolicy’, users can specify the output formats and destinations for the inferencing results. The ‘OutputLogFile’ and ‘OutputVideoFile’ fields determine the filenames for textual logs and video recordings, respectively. This enables the detailed documentation of detected events, facilitating easy review and further analysis.

### 2.2.4 Data Publishing

The ‘Publish’ section outlines the configuration for disseminating inferencing outcomes. This includes the destination node (′Node: “A.B.C.D”), port (′Port: “4222”), and specific stream (′Stream: “Detector”′) and subject (Subject: “Detector.Watcher1”′) identifiers. Such granularity in publication settings empowers users to integrate the inferencing system seamlessly into broader monitoring or analytic frameworks.

### 2.2.5 Viewpoints Specification

The core of the DSL's inferencing configuration lies within the ‘Viewpoints’ section. Here, users can define multiple ‘Viewpoints’, each with a unique ‘Id’ and a ‘Polygon’ specifying the area of interest within the video frame. The polygon points outline the precise spatial region to be monitored, enabling targeted analysis and reducing unnecessary processing.

Each viewpoint includes ‘Record’ directives for multiple operations including but not limited to ‘Count’, ‘Identify’, ‘Motion’, ‘Speed’, ‘Shape’, ‘Calculate’, ‘Presence and ‘Color’ specifying the types of detectors (′Detector: “Person”′ or ‘“PersonPose”) and their confidence thresholds (′Confidence: 0.7’ or ‘0.5’). This level of detail in specifying what to detect and with what confidence allows for highly customized and accurate inferencing tasks, tailored to the unique needs of each monitoring scenario.

By leveraging this DSL, users are equipped with a powerful tool for articulating comprehensive video inferencing specifications. The DSL's structured yet flexible design ensures that users can define sophisticated surveillance and analysis tasks, from specifying source video streams to detailing the exact parameters for detection and recording. This approach not only enhances the system's versatility and applicability across various use cases but also democratizes access to advanced video analytics capabilities, enabling users to deploy complex monitoring solutions with ease.

The intricate relationship between the various sections of the Domain-Specific Language (DSL) is pivotal for orchestrating a cohesive and efficient video inferencing system. Each section, while independently specifying certain aspects of the video analysis process, interconnects with others to form a comprehensive surveillance solution. Understanding these relationships is crucial for leveraging the full potential of the DSL to configure and implement advanced video inferencing tasks.

### 2.2.6 Interplay Between Video Stream, Viewpoints and Watchers

The ‘VideoStream’ configuration serves as the foundational input for the system, specifying the source of video data. The ‘Viewpoints’ section, with its detailed area definitions within the video frame, directly depends on the source specified in ‘VideoStream’. This relationship ensures that area-specific inferencing, such as object detection or behavior analysis, is accurately aligned with the provided video feed, whether it be a live stream or a recorded file. Identified Viewpoints are analyzed using the inference modules called ‘Watchers’ which actually perform the object detection or behavior analysis and create records for the significant events of interest specified in the DSL.

### 2.2.7 Synchronization of Inferencing Interval with Recording and Publishing

The ‘IntervalTimeInSeconds’ setting determines the frequency at which the video is sampled for analysis. This setting is closely linked with both the ‘RecordCreationPolicy” and the ‘Publish’ configurations. The temporal granularity defined by the inferencing interval dictates the cadence of data logging and publishing, ensuring that the output files and published data accurately reflect the specified interval. This synchronization guarantees that recorded and published data are both temporally consistent and aligned with the user-defined inferencing schedule.

### 2.2.8 Coordination Between Viewpoints and Recording Policies

Each ‘Viewpoint’ defined within the DSL specifies targeted areas for inferencing, along with directives for counting and identifying specific objects or behaviors. The ‘RecordCreationPolicy’ complements this by outlining how and where these detection results are recorded. The relationship between viewpoints and recording policies ensures that the outcomes of area-specific detections are systematically documented according to user preferences, facilitating detailed analysis and review of inferencing results.

### 2.2.9 Comprehensive Integration Through Data Publishing

The ‘Publish’ section's role in defining how inferencing outcomes are communicated to external systems or platforms is essential for integrating the video inferencing system into broader operational frameworks. This section's specifications must align with the detection and recording activities defined in the ‘Viewpoints’ and ‘RecordCreationPolicy” sections. By establishing a direct line for data dissemination, this integration ensures that the results of the video analysis are readily available for real-time monitoring, further processing, or integration into larger data ecosystems.

### 2.2.10 Unified System Operation

The DSL's design intricately weaves together these sections, ensuring a unified operation of the video inferencing system. The video stream sources feed into the specified viewpoints for targeted analysis. The inferencing interval influences the timing of data capture and analysis, while the recording policies and data publishing mechanisms dictate how and where these results are stored and shared. This cohesive interrelation amplifies the system's efficiency, enabling precise, configurable, and scalable video inferencing solutions tailored to diverse monitoring and analysis needs.

In summary, the DSL's structured yet flexible sections are designed to interlock seamlessly, forming a robust framework for configuring comprehensive video inferencing tasks. This harmonious interplay ensures that users can define highly detailed and customized surveillance specifications, empowering them to address specific monitoring objectives with precision and efficiency.

### 2.3 Sample Inferencing File

### VideoStream:

File: ″″
URL: ″″

### Interval TimeInSeconds: 10

### RecordCreationPolicy:

OutputLogFile: “Watcher1.log”
OutputVideoFile: “Watcher1.mp4”

### Publish:

Node: “A.B.C.D”
Port: “4222”
Stream: “Detector”
Subject: “Detector.Watcher1”

### Viewpoints:

Id: “Viewpoint1”
   Polygon:
      [0, 0]
      [0, 100]
      [100, 100]
      [100, 0]
   Record:
      Count:
         Confidence: 0.7
         Detector: “PersonPose”
         Confidence: 0.5
      Identify:
         Detector: “Person”
         Confidence: 0.7
         Detector: “PersonPose”
         Confidence: 0.5
Id: “Viewpoint2”
   Polygon:
      [0, 0]
      [0, 200]
      [200, 200]
      [200, 0]
   Record:
      Count:
         Detector: “Person”
         Confidence: 0.7
         Detector: “PersonPose”
         Confidence: 0.5
      Identify:
         Confidence: 0.7
         Detector: “PersonPose”
         Confidence: 0.5
Id: “Viewpoint3”
   Polygon:
      [0, 0]
      [0, 20]
      [20, 20]
      [20, 0]
   Record:
      Presence:
         Detector: “Motion”
         Confidence: 0.7
Id: “Viewpoint4”
   Polygon:
      [0, 0]
      [0, 20]
      [20, 20]
      [20, 0]
   Record:
   Calculate:
      Detector: “Speed”
      Confidence: 0.7
Id: “Viewpoint5”
   Polygon:
      [0, 0]
      [0, 20]
      [20, 20]
      [20, 0]
   Record:
      Calculate:
         Detector: “Color”
         Color: “FF0000”
         Confidence: 0.7

### 2.4 System Design and Operation

The design of the video inferencing system is predicated on a modular architecture that facilitates efficient parsing of the Domain-Specific Language (DSL), dynamic allocation of inferencing tasks, and seamless coordination between various system components. Central to this architecture is the orchestrator module, which serves as the linchpin for interpreting the DSL (specified in formats such as YAML, JSON, or other variations) and managing the execution flow across the inferencing modules. This section delves into the orchestrator's role, the structure of inferencing modules, and their collaborative operation to fulfill the comprehensive video analysis tasks defined by the user.

### 2.4.1 Orchestrator Module

The orchestrator module acts as the initial point of contact with the DSL configuration file. Upon receiving the file, the orchestrator performs several critical functions:

DSL Parsing: It parses the DSL to extract global configurations such as video stream sources, inferencing intervals, and recording policies. This parsing process involves interpreting the DSL's syntax and semantics, converting them into an internal representation that guides the system's operation.

Inferencing Task Allocation: Based on the parsed DSL, the orchestrator identifies the specific inferencing modules (watchers) required for the specified tasks. It allocates these tasks according to the defined viewpoints and their associated detectors, ensuring that each module is tasked with analyzing the designated areas of interest within the video stream.

Module Configuration: The orchestrator configures each inferencing module with the necessary parameters extracted from the DSL. This includes the details of the video stream to analyze, the polygons defining the viewpoints, and the specific detectors to employ for object or behavior identification.

### 2.4.2 Inferencing Modules

The inferencing modules, or watchers, are specialized components responsible for performing the actual video analysis tasks. Each module is designed to process a segment of the video stream corresponding to specified viewpoints and apply the designated detectors. These modules operate under the orchestrator's guidance, adhering to the configurations passed down from the DSL. Their functions include:

Viewpoint Processing: Inferencing modules interpret the DSL to isolate their assigned viewpoints within the video stream. This involves mapping the polygon coordinates to the video frame and focusing the analysis on these areas.

Detector Application: Within their allocated viewpoints, modules apply the specified detectors to identify objects or behaviors. This process is guided by the confidence thresholds and other parameters defined in the DSL, ensuring that the detection aligns with user expectations.

Result Recording and Publishing: Consistent with the recording policies and publishing configurations defined in the DSL, inferencing modules generate logs, video snippets, or other forms of output documenting the detection results. These outputs are then stored or published according to the specified policies, ensuring that the information is captured and disseminated as intended.

### 2.4.3 System Operation

The orchestrated operation begins with the orchestrator parsing the DSL and distributing tasks to the inferencing modules. As the video stream is processed, each module applies its designated detectors within the assigned viewpoints, generating detection results. These results are then recorded or published, forming a continuous cycle of analysis, documentation, and communication.

This modular design, anchored by the orchestrator's central coordination role, ensures that the video inferencing system is both flexible and scalable. It allows for easy adaptation to different video sources, analysis tasks, and output requirements, all specified through the DSL. The design's modularity also facilitates the integration of new detectors or analysis capabilities, ensuring that the system can evolve to meet emerging surveillance and analysis needs.

In conclusion, the system's architecture, with its orchestrator-led coordination and specialized inferencing modules, embodies a robust framework for implementing comprehensive video analysis tasks. This design enables precise execution of user-defined specifications, ensuring that the system can meet diverse and complex inferencing requirements with high efficiency and adaptability.

### 2.5 Enhanced Integration Capabilities with Industrial Communication Protocols

The video inferencing system described not only integrates seamlessly with industrial management systems including but not limited to Supervisory Control and Data Acquisition (SCADA), Manufacturing Execution System (MES), Enterprise Resource Planning (ERP), Supply Chain Management (SCM), Customer Relationship Management (CRM), and Warehouse Management System (WMS), but also extends its interoperability to include direct communication with Programmable Logic Controllers (PLC), IO-Link devices, support for widely used industrial protocols such as OPC UA (Open Platform Communications Unified Architecture) and MQTT (Message Queuing Telemetry Transport), and integration with connected vehicles. This enhanced integration capability is crucial for deploying video inferencing solutions that can interact directly with industrial automation components, leverage real-time data exchange protocols, and facilitate communication with connected vehicles, thereby broadening the system's application in industrial settings and enhancing its utility in modern transportation and logistics operations.

### 2.5.1 Enhanced Communication Interface Module

The core of this extended interoperability lies in the enhanced communication interface module, which incorporates functionalities tailored to interact with a wider array of industrial communication standards and devices:
PLC and IO-Link Communication: The module facilitates direct communication with Programmable Logic Controllers (PLC) and IO-Link devices, enabling the video inferencing system to trigger actions or receive signals based on the analysis of video streams. This capability is vital for applications requiring immediate response or adjustment of machinery and processes based on visual data insights.
OPC UA Integration: By integrating with OPC UA, the system adopts a secure and reliable method for exchanging data with industrial equipment and software, adhering to a widely recognized standard for industrial automation. This integration ensures compatibility and interoperability within complex industrial environments, allowing for seamless data flow between the video inferencing system and other OPC UA-compliant devices or systems.
MQTT Protocol Support: The inclusion of MQTT protocol support enhances the system's ability to publish inferencing data to a broader network, leveraging a lightweight and efficient messaging protocol designed for small sensors and mobile devices in all types of networks. This functionality is particularly beneficial for IoT applications and scenarios where bandwidth is limited.

### 2.6 Illustrative Examples and Use Case Scenarios

This section provides practical illustrations of how the enhanced video inferencing system can be deployed across various industries, showcasing its versatility and the breadth of its application. These examples and scenarios highlight the system's integration capabilities with industrial management systems, communication protocols, and its adaptability to meet specific operational needs.

### Example 1: Industrial Safety and Productivity Monitoring

Scenario: In a manufacturing facility, the system is configured to monitor machinery and worker interactions to enhance safety and productivity. Video inferencing modules analyze video streams to detect unauthorized access to restricted areas, identify potential safety hazards, and monitor worker adherence to safety protocols. Integration with the facility's MES system enables real-time alerts and automated logging of safety incidents, while direct communication with PLCs allows for immediate machinery shutdown in response to detected hazards.

Outcome: Improved safety compliance, reduced incident response time, and enhanced operational efficiency through automated monitoring and intervention.

### Example 2: Retail Customer Behavior Analysis and Inventory Management

Scenario: A retail store implements the system to analyze customer behavior patterns and manage inventory levels. Video streams are analyzed to track customer movements, identify high-traffic areas, and monitor stock levels on shelves. The system integrates with the store's ERP and WMS to update inventory levels in real-time, trigger restocking processes, and generate insights into customer preferences and behaviors.

Outcome: Optimized inventory management, improved customer experience through layout adjustments, and data-driven marketing strategies.

### Example 3: Traffic Flow Optimization

Scenario: A city's traffic management center uses the system to optimize traffic flow and enhance road safety. Video inferencing modules analyze streams from multiple traffic cameras, detecting congestion, accidents, and pedestrian movements. Integration with the city's SCADA system allows for adaptive traffic signal control based on real-time traffic conditions, while MQTT protocol support enables the dissemination of traffic alerts to drivers via mobile apps.

Outcome: Reduced traffic congestion, quicker emergency response, and enhanced road safety.

### Example 4: Agricultural Yield Analysis

Scenario: An agricultural operation employs the system to monitor crop growth and predict yields. Video analysis is used to assess crop health, detect areas requiring intervention, and estimate yield based on visual indicators. Data integration with the operation's ERP system facilitates the planning of harvest operations and supply chain logistics, ensuring optimal yield management.

Outcome: Increased operational efficiency, optimized yield predictions, and reduced waste through targeted interventions.

### Example 5: Environmental Monitoring for Conservation Efforts

Scenario: A conservation organization uses the system to monitor wildlife activity and environmental conditions in protected areas. Video inferencing modules analyze video feeds from remote cameras to track animal populations, detect poaching activity, and assess environmental health. Integration with data analysis platforms allows for the compilation of long-term environmental data, supporting conservation planning and public awareness efforts.

Outcome: Enhanced conservation efforts through continuous monitoring, data-driven decision-making, and increased public engagement.

### 3. Variations or Alternative Embodiments of the Invention

The present invention, while described in detail through a specific implementation involving a Domain-Specific Language (DSL) for video inferencing and a modular system architecture, is not limited to these descriptions. The invention encompasses a broad range of variations and alternative embodiments, each designed to cater to different use cases, technological environments, and user preferences. This section outlines several such variations, emphasizing the invention's adaptability and potential for customization.

### 3.1 Alternative Configuration Languages

Generalization to Other Markup Languages: While the DSL has been primarily illustrated using YAML for its readability and simplicity, the invention is equally applicable to other data serialization languages such as JSON, XML, or TOML. The choice of language can be tailored to the user's familiarity, the complexity of the configuration, or the integration requirements with other systems.
Graphical Configuration Interfaces: An alternative embodiment could involve a graphical user interface (GUI) that allows users to visually define the video inferencing specifications. This GUI could generate the underlying DSL or other markup language representations, making the system accessible to users without programming or scripting experience.

### 3.2 Modular System Extensions

Plug-and-Play Detectors: The system can be designed to support a plug-and-play mechanism for integrating additional detectors or analytics modules. This would allow users to extend the system's capabilities by adding new types of object detection, behavior analysis, or other video processing functionalities without extensive reconfiguration.
Dynamic Resource Allocation: An alternative system design could incorporate dynamic resource allocation and scaling mechanisms. Based on the workload, video stream complexity, or real-time performance metrics, the system could automatically adjust the allocation of computational resources or parallelize tasks to optimize performance.

### 3.3 Enhanced Data Management and Utilization

Advanced Data Recording Policies: Beyond basic recording and publishing policies, alternative embodiments could introduce more sophisticated data management strategies. These could include conditional recording based on specific event detection, automatic data expiration for non-critical information, or integration with cloud storage services for scalable data archiving.
Real-Time Data Analytics and Feedback Loops: Variations of the system could incorporate real-time analytics on the inferencing outputs, providing immediate insights or triggering actions based on the analysis results. This could be extended to include feedback loops where the system's performance data informs adaptive adjustments to the inferencing parameters or task allocations for continuous improvement.

### 3.4 Cross-Domain Applications

Adaptation to Non-Video Data Streams: While the invention has been described with a focus on video data, the principles and architecture could be adapted to apply to other types of data streams. This includes audio analysis, real-time sensor data processing, or any context where dynamic, complex data requires structured analysis and response.
Integration with IoT and Smart Environments: The system could be embodied within Internet of Things (IoT) frameworks or smart environment applications. This would enable the direct application of video inferencing in context-aware systems, enhancing automation and responsiveness in smart homes, cities, and industrial settings.

The invention's flexibility and the potential for diverse embodiments underscore its broad applicability and adaptability to evolving technological landscapes and user needs. These variations and alternatives embody the invention's spirit and scope, extending its utility beyond the specific implementations described herein.

1: A System for Configurable Video Inferencing
A system for configurable video inferencing, comprising:
a processor configured for operation of:
an orchestrator parsing a domain-specific language (DSL) input specifying video sources, streams, viewpoints, watchers (inferencing modules), detectors for object or behavior identification, and recording policies;
a plurality of inferencing watchers dynamically allocated by the orchestrator, each inferencing module configured to process designated video streams according to specified viewpoints and apply detectors as defined in the DSL input; and
a recorder configured to implement recording policies based on intervals and conditions specified in the DSL input, wherein said policies dictate the frequency of frame analysis and the storage mechanism for inferencing results;
wherein the system is adapted to receive DSL inputs comprising one or more of YAML and JSON to provide for specification of video inferencing tasks across multiple cameras and viewpoints.

2: The system of claim 1, wherein the video sources include at least one of live video streams, recorded video files, and direct camera feeds, each uniquely identified within the DSL to allow for simultaneous monitoring across multiple inputs.

3: The system of claim 1, further comprising a dynamic allocation mechanism within the orchestrator, configured to instantiate and assign inferencing modules (watchers) to video streams based on the configurations specified in the DSL, allowing for real-time adaptation to changing monitoring needs.

4: The system of claim 1, wherein each inferencing watcher utilizes a set of pre-defined detectors capable of identifying a range of objects or behaviors as specified in the DSL, comprising one or more of identification, detection, classification, segmentation and extraction of person, person pose, person face, person action, person emotion, animal, animal pose, animal action, animal emotion, object detection, object, color, shape, speed, group pose, and group action.

5: The system of claim 1, wherein the recorder is configured to implement complex recording policies specified in the DSL, including conditional recording based on detection confidence levels, event occurrence, or time-based criteria, thereby optimizing storage and processing resources.

6: The system of claim 1, wherein the system capable of interpreting and executing configurations specified in various DSL formats comprising one or more of JSON and XML, to provide flexibility in defining inferencing specifications according to user preferences or existing system integrations.

7: The system of claim 1, wherein the DSL supports the specification of an unlimited number of viewpoint polygons within each video source, allowing users to target specific areas of interest for analysis, thereby enhancing the precision and relevance of the surveillance outputs.

8: The system of claim 1, featuring an integrated publication module designed to automatically disseminate inferencing results according to the DSL-defined publication parameters, including network endpoints, protocols, and data formats, facilitating seamless integration with external data analysis platforms or alerting systems.

9: The system of claim 1, further comprising a graphical user interface (GUI) that enables users to visually define inferencing specifications, automatically generating the DSL configuration input, thereby making the system accessible to users without programming expertise.

10: A method for dynamic video stream inferencing, executed on a computing device, the method comprising the steps of:
receiving a configuration input in a domain-specific language (DSL), the configuration specifying at least one video source, one or more viewpoints within the video source, inferencing modules (watchers) associated with the viewpoints, detectors for identifying objects or behaviors, and recording policies;
parsing the DSL input to extract configurations for video sources, viewpoints, watchers, detectors, and recording policies;
allocating video streams to inferencing modules based on the viewpoints specified in the DSL input, wherein each inferencing module is responsible for analyzing its allocated video stream to detect objects or behaviors as per the detectors specified;
applying recording policies to control the frequency of frame analysis and the storage of inferencing results, as specified in the DSL input;
wherein the method dynamically adapts to changes in the DSL input, enabling flexible and scalable video inferencing configurations for real-time or recorded video analysis.

11: The method of claim 10, wherein the system dynamically adapts to real-time changes in the DSL input, allowing for on-the-fly modification of video sources, viewpoints, detectors, and recording policies without interruption to ongoing inferencing operations.

12: The method of claim 10, further comprising automated detection and configuration of viewpoints within video streams, utilizing machine learning algorithms to identify areas of interest based on historical data or predefined criteria for enhancing the efficiency and accuracy of object and behavior detection.

13: The method of claim 10, further comprising an adaptive mechanism for selecting and configuring detectors based on the specific characteristics of the video source and the targeted objects or behaviors, wherein recording policies include conditional logic based on the outcomes of detection tasks to record only when specific objects are detected or behaviors are observed in order to optimize storage utilization and focus analysis on relevant events.

14: The method of claim 10, wherein the method is capable of generating inferencing results in multiple data formats, including textual logs, annotated video files, and structured data outputs, providing flexibility in how results are documented and utilized for further analysis or integration.

15: The method of claim 10, wherein the method employing parallel processing techniques to analyze multiple video streams and viewpoints concurrently, significantly enhancing the system's scalability and performance in handling high-volume or high-complexity video analysis tasks.

16: The method of claim 10, wherein the method incorporates a feedback mechanism that utilizes inferencing outcomes to refine and improve the detection algorithms, recording strategies, and overall system configuration, fostering continuous improvement in accuracy and efficiency.

17: An enhanced video inferencing system configured for comprehensive integration with industrial management systems and communication protocols, comprising:
a plurality of video inferencers designed to analyze video streams from multiple sources and generate corresponding inferencing data;
an orchestrator responsible for coordinating the operations of the video inferencing modules and managing data flow within the system;
an enhanced communication interface specifically configured to establish data exchange protocols with one or more industrial management systems, including SCADA, MES, ERP, SCM, CRM, WMS, and direct communication with Programmable Logic Controllers (PLC), IO-Link devices, and support for industrial protocols such as OPC UA and MQTT, wherein the communication interface module formats the inferencing data for compatibility and facilitates secure and efficient data exchange with the operational and data reception standards of the industrial management systems and protocols.

18: The system of claim 17, wherein the enhanced communication interface is further configured to directly interact with PLC and IO-Link devices, enabling the video inferencing system to trigger actions or receive signals based on video analysis, enhancing real-time operational control based on visual data insights.

19: The system of claim 17, further comprising OPC UA integration capabilities within the communication interface, ensuring secure and standardized data exchange with a wide range of industrial automation systems and equipment, facilitating interoperability within complex industrial environments.

20: The system of claim 17, further comprising support for MQTT protocol in the communication interface, optimizing the publication of inferencing data for IoT applications and ensuring efficient messaging in bandwidth-limited environments.
